(19) United States
(12) Patent Application Publication
(10) Pub. No.: US 2005/0068183 A1
(43) Pub. Date: Mar. 31, 2005

(54) Security system and security method

(76) Inventor: Tomokazu Yuasa, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/944,881

(22) Filed: Sep. 21, 2004

(30) Foreign Application Priority Data
Sep. 30, 2003 (JP) 2003-340694

(51) Int. Cl. G06K 9/00

(52) U.S. Cl. 340/573.1

(57) ABSTRACT

A security system includes an analyzer configured to perform voiceprint analysis for bark of an animal, and a communication unit configured to transmit information representing a peripheral situation around the animal to a terminal when the analyzer detects a voiceprint representing a threat.

### CROSS-REFERENCE TO RELATED APPLICATIONS

This application is based upon and claims the benefit of priority from prior Japanese Patent Application No. 2003-340694, filed Sep. 30, 2003, the entire contents of which are incorporated herein by reference.

### BACKGROUND OF THE INVENTION

1. Field of the Invention

The present invention relates to a security system and security method for monitoring a suspicious person possibly attempting to break into a house or the like.

2. Description of the Related Art

Conventionally, in order to prevent someone from breaking into a house, a watchdog or the like is often utilized. A person in the house can sense an abnormal situation by hearing the bark of the watchdog.

U.S. Patent Application No. 6,535,131 B1 discloses a technique of attaching to the neck of an animal a device which is connected to a base station by radio, and transmitting, from the device to the base station, the voice of the animal when it feels pain.

Japanese Utility Model Registration No. 3083915 discloses a technique of discriminating various feelings from the bark of a dog.

However, if the watchdog barks furiously at a suspicious person who comes while the resident is out, the resident cannot notice it. Also, although it may be possible to notify the resident out of the house of the feeling of the barking watchdog by using a communication technique, the resident cannot know in detail what is happening around the watchdog. For example, if a suspicious person appears, the resident out of the house cannot confirm the face and figure of the suspicious person.

Accordingly, there is a need to provide a technique of allowing recognition out of the house of a peripheral situation such as that in which a suspicious person attempts to break into the house.

### BRIEF SUMMARY OF THE INVENTION

According to one aspect of the present invention, there is provided a security system comprising an analyzer configured to perform voiceprint analysis for bark of an animal; and a communication unit configured to transmit information representing a peripheral situation around the animal to a terminal when the analyzer detects a voiceprint representing a threat.

According to another aspect of the present invention, there is provided a security method comprising performing voiceprint analysis for bark of an animal; and transmitting at least part of information representing a peripheral situation around the animal to a terminal when a voiceprint representing a threat is detected in the analysis.

According to another aspect of the present invention, there is provided a security method comprising performing voiceprint analysis for bark of a specific animal; storing information representing a peripheral situation around the animal in an information storage apparatus when a voiceprint representing a threat is detected in the analysis; and playing back the information stored in the information storage apparatus in response to a playback response.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the configuration of a security system according to the first embodiment of the present invention;

FIG. 2 is a block diagram for explaining the arrangements of an electronic apparatus and information storage apparatus in the first embodiment;

FIG. 3 is a block diagram for explaining the arrangement of a portable information terminal;

FIG. 4 is a flowchart showing the operation in the first embodiment;

FIG. 5 is a view showing the configuration of a security system according to the second embodiment of the present invention;

FIG. 6 is a block diagram for explaining the arrangements of an electronic apparatus and camera device in the second embodiment;

FIG. 7 is a flowchart showing the operation in the second embodiment;

FIG. 8 is a view showing the configuration of a security system according to the third embodiment of the present invention;

FIG. 9 is a block diagram for explaining the arrangements of an electronic apparatus and information storage apparatus in the third embodiment;

FIG. 10 is a flowchart showing the operation in the third embodiment;

FIG. 11 is a view showing the configuration of a security system according to the fourth embodiment of the present invention;

FIG. 12 is a block diagram for explaining the arrangements of an electronic apparatus, camera device, and information storage apparatus in the fourth embodiment; and

FIG. 13 is a flowchart showing the operation in the fourth embodiment.

### DETAILED DESCRIPTION OF THE INVENTION

Embodiments of the present invention will be described below with reference to the drawings.

(First Embodiment)

The first embodiment of the present invention will be explained.

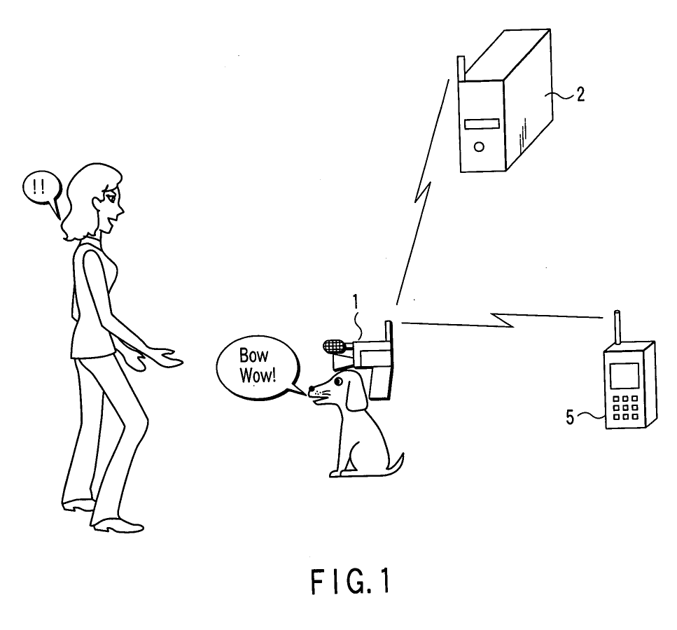

FIG. 1 is a view showing the configuration of a security system according to the first embodiment of the present invention.

In the first embodiment, when a watchdog expresses a feeling of threat against a suspicious person, the situation around the watchdog is directly transmitted from an electronic apparatus attached to the watchdog to a portable information terminal held by the resident.

As shown in FIG. 1, the security system includes an electronic apparatus 1, information storage apparatus 2, and portable information terminal 5.

The electronic apparatus 1 is equipped with a microphone and camera, and is attached to the head of the watchdog. In this case, the camera lens is so fixed as to face the front as viewed from the watchdog.

The electronic apparatus 1 performs voiceprint analysis of the bark of the watchdog. If a voiceprint representing a threat is detected in the voice analysis, image information and audio information are, for example, wirelessly transmitted as information representing a peripheral situation to the information storage apparatus 2. At least part of the information is, for example, wirelessly transmitted to the portable information terminal 5. In transmission to the portable information terminal 5, for example, a still image may be transmitted every predetermined interval, or a moving image within a predetermined time may be transmitted. A combination of such image information and text information such as a message may be transmitted.

The information storage apparatus 2 corresponds to, e.g., a home server, and includes a storage medium capable of storing large amounts of image information and audio information. The information storage apparatus 2 receives information transmitted from the electronic apparatus 1, and stores it on the storage medium. When a playback request is received, information can be played back via an AV device 26 (monitor, loudspeaker, or the like) connected to the information storage apparatus 2.

The portable information terminal 5 corresponds to, e.g., a PDA or cellphone, and is held by the person who owns the watchdog, within a range where radio waves from the electronic apparatus 1 can reach the terminal 5. The portable information terminal 5 receives information transmitted from the electronic apparatus 1, displays an image on the screen of the display, and outputs a voice from the loudspeaker. The person who carries the portable information terminal 5 with him can operate the portable information terminal 5 to notify a security company or the police of the situation by voice communication or transfer an image or text information. The person can also operate the portable information terminal 5 to generate an alarm sound against a peripheral situation from the loudspeaker of the electronic apparatus 1.

The arrangements of the electronic apparatus 1 and information storage apparatus 2 will be explained with reference to FIG. 2.

The electronic apparatus 1 includes a microphone 11, voice analyzer 12, camera 13, memory 14, communication unit 15, antenna 16, loudspeaker 17, controller 18, and battery 19.

The microphone 11 collects peripheral voices, particularly the bark of the watchdog.

The voice analyzer 12 analyzes a voiceprint from the bark of the watchdog that is acquired via the microphone 11, and determines various feelings. Especially when a voiceprint representing a threat is detected, the voice analyzer 12 notifies the controller 18 with a message to this effect. A feeling of threat corresponds to a voice pattern in which a voice having a fundamental wave of 240 to 360 Hz, a definite harmonic of up to 1,500 Hz, and then a harmonic of up to 8,000 Hz continues for 0.8 to 1.5 sec after a voice of 250 to 8,000 Hz having a strong frequency component around 1,000 Hz without any definite fundamental wave and harmonic.

The camera 13 photographs a peripheral situation. For example, when a suspicious person enters the field of view of the camera, the camera 13 acquires an image of the suspicious person as a moving image or a still image every predetermined interval.

The memory 14 is, e.g., a buffer, and stores a voice collected by the microphone 11 and an image photographed by the camera 13.

The communication unit 15 is a communication device complying with wireless LAN, Bluetooth®, or the like. The communication unit 15 wirelessly communicates with the information storage apparatus 2 and portable information terminal 5.

The antenna 16 transmits and receives radio waves in wireless communication with the information storage apparatus 2 and wireless communication with the portable information terminal 5.

The loudspeaker 17 outputs a voice, and generates, e.g., a sound (alarm sound or human voice) corresponding to an instruction sent from the portable information terminal 5 via wireless communication.

The controller 18 is a processor which controls the operation of the overall electronic apparatus 1. For example, when the voice analyzer 12 detects a voiceprint representing a threat, the controller 18 controls to wirelessly transmit image information and audio information as information representing a peripheral situation from the communication unit 15 to the information storage apparatus 2 and wirelessly transmit at least part of the information to the portable information terminal 5.

The battery 19 is a power supply necessary to operate the electronic apparatus 1.

The information storage apparatus 2 includes a communication unit 21, an antenna 22, a storage device 23, a controller 24, and the AV device 26.

The communication unit 21 is a communication device complying with wireless LAN, Bluetooth®, or the like, and wirelessly communicates with the electronic apparatus 1.

The antenna 22 transmits and receives radio waves in wireless communication with the electronic apparatus 1.

The storage device 23 is a storage medium (e.g., hard disk) capable of storing large amounts of image information and audio information.

The controller 24 is a processor which controls the operation of the whole information storage apparatus 2, and stores, e.g., image information and audio information sent from the electronic apparatus 1 in the storage device 23.

The AV device 26 plays back image information and audio information which are stored in the storage device 23.

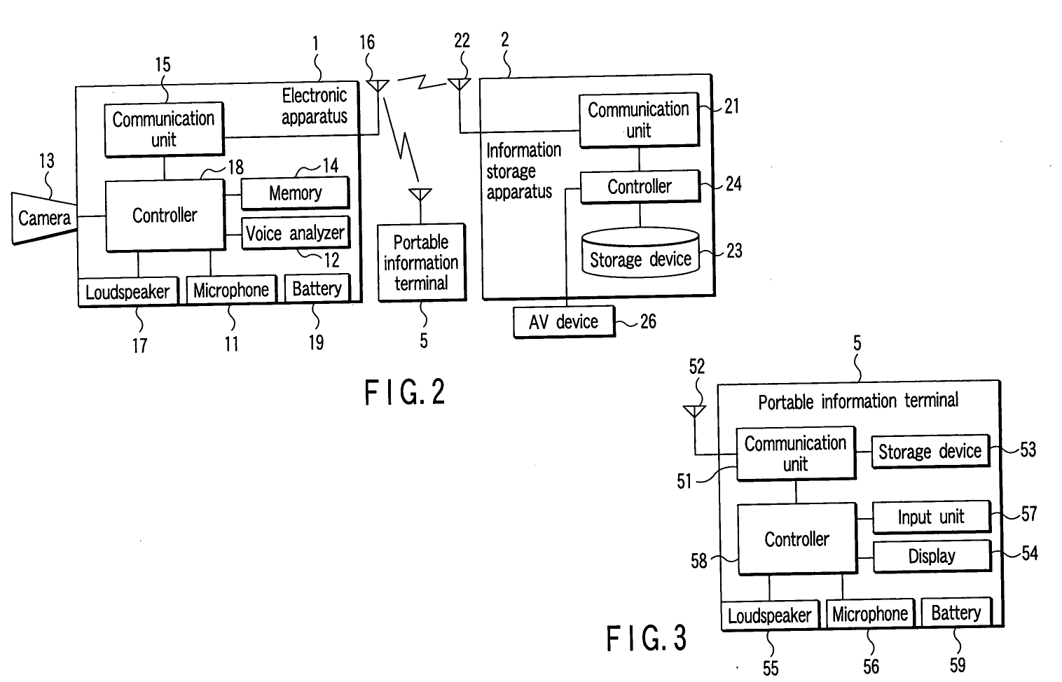

The arrangement of the portable information terminal 5 will be described with reference to FIG. 3.

The portable information terminal 5 shown in FIG. 3 is also applied to the following embodiments.

The portable information terminal 5 includes a communication unit 51, antenna 52, storage device 53, display 54, loudspeaker 55, microphone 56, input unit 57, controller 58, and battery 59.

The communication unit 51 is a communication device complying with wireless LAN, Bluetooth®, or the like, and wirelessly communicates with the electronic apparatus 1. The communication unit 51 may include a device for voice communication with another device via a telephone line.

The antenna 52 transmits and receives radio waves in wireless communication with the electronic apparatus 1.

The storage device 53 is a memory which stores image information, audio information, and the like transmitted from the electronic apparatus 1.

The display 54 displays image information and the like transmitted from the electronic apparatus 1.

The loudspeaker 55 outputs audio information or the like transmitted from the electronic apparatus 1.

The microphone 56 collects peripheral voices.

The input unit 57 allows the user to perform various input operations.

The controller 58 is a processor which controls the operation of the overall portable information terminal 5. The controller 58 controls to output from the display 54 and loudspeaker 55, e.g., image information and audio information transmitted from the electronic apparatus 1. The controller 58 also controls to perform voice communication in accordance with an input operation by the user, and controls to transfer image information and text information to a security company or the like.

The battery 59 is a power supply necessary to operate the portable information terminal 5.

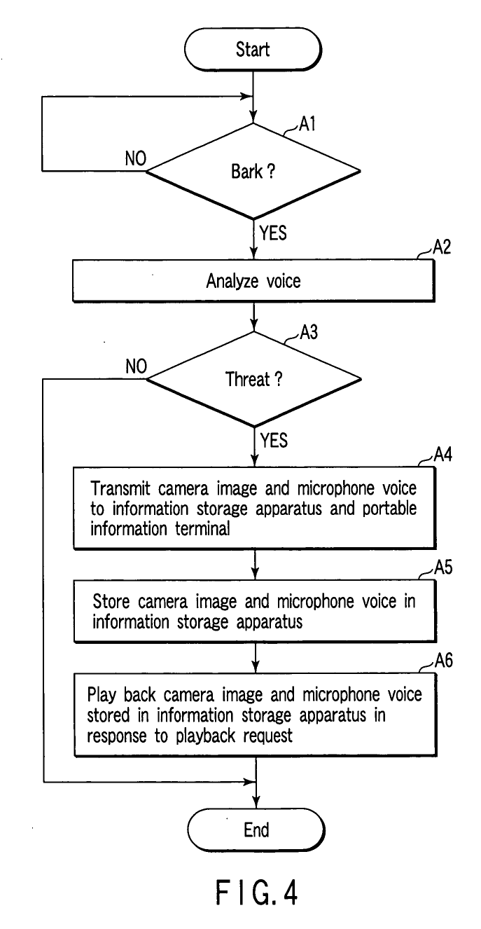

The operation in the first embodiment will be explained with reference to FIG. 4.

In the electronic apparatus 1, the controller 18 waits until the bark of the watchdog is detected via the microphone 11 (NO in step A1). If the bark of the watchdog is detected (YES in step A1), the voice analyzer 12 analyzes the voiceprint (step A2). If no voiceprint representing a threat is detected (NO in step A3), the process ends. If a voiceprint representing a threat is detected (YES in step A3), the controller 18 transmits information containing image information photographed by the camera 13 and audio information collected by the microphone 11 to the information storage apparatus 2 via the communication unit 15, and transmits at least part of the information to the portable information terminal 5 (step A4). The image information and audio information are respectively output from the display 54 and loudspeaker 55 of the portable information terminal 5. A person who carries the portable information terminal 5 with him can recognize the current situation around the watchdog.

In the information storage apparatus 2, the controller 24 stores in the storage device 23 the image information and audio information which have been received via the communication unit 21 (step A5). When a playback request is received, the controller 24 plays back the image information and audio information stored in the storage device 23 via the AV device 26 connected to the information storage apparatus 2 (step A6).

According to the first embodiment, when the watchdog expresses a threat against a suspicious person, the peripheral situation is directly transmitted as image information and audio information to the portable information terminal 5. A person who carries the portable information terminal 5 with him can quickly grasp the current situation around the watchdog.

(Second Embodiment)

The second embodiment of the present invention will be explained. The same reference numerals as in the above-described embodiment denote the same parts, and a detailed description thereof will be omitted.

FIG. 5 is a view showing the configuration of a security system according to the second embodiment of the present invention.

In the second embodiment, a camera is separated from an electronic apparatus in the configuration of the first embodiment (see FIG. 1).

As shown in FIG. 5, the security system includes an electronic apparatus 1A, camera device 1B, information storage apparatus 2, and portable information terminal 5.

The electronic apparatus 1A is identical to the electronic apparatus 1 described in the first embodiment except that the electronic apparatus 1A does not have any camera. When a voiceprint representing a threat is detected in voiceprint analysis of the bark of a watchdog, the electronic apparatus 1A wirelessly transmits audio information as information representing a peripheral situation to the camera device 1B.

The camera device 1B is set at a place where a suspicious person can be easily photographed, for example, in the garden of a house or on the roof or a pillar. When audio information is sent from the electronic apparatus 1A, the camera device 1B transmits information as a combination of image information photographed by the camera device 1B and the audio information to the information storage apparatus 2 by, e.g., wire. Also, the camera device 1B, e.g., wirelessly transmits at least part of the information to the portable information terminal 5.

The information storage apparatus 2 is identical to that described in the first embodiment. The information storage apparatus 2 according to the second embodiment receives information transmitted from the camera device 1B.

The portable information terminal 5 is identical to that described in the first embodiment. The portable information terminal 5 according to the second embodiment receives information transmitted from the camera device 1B.

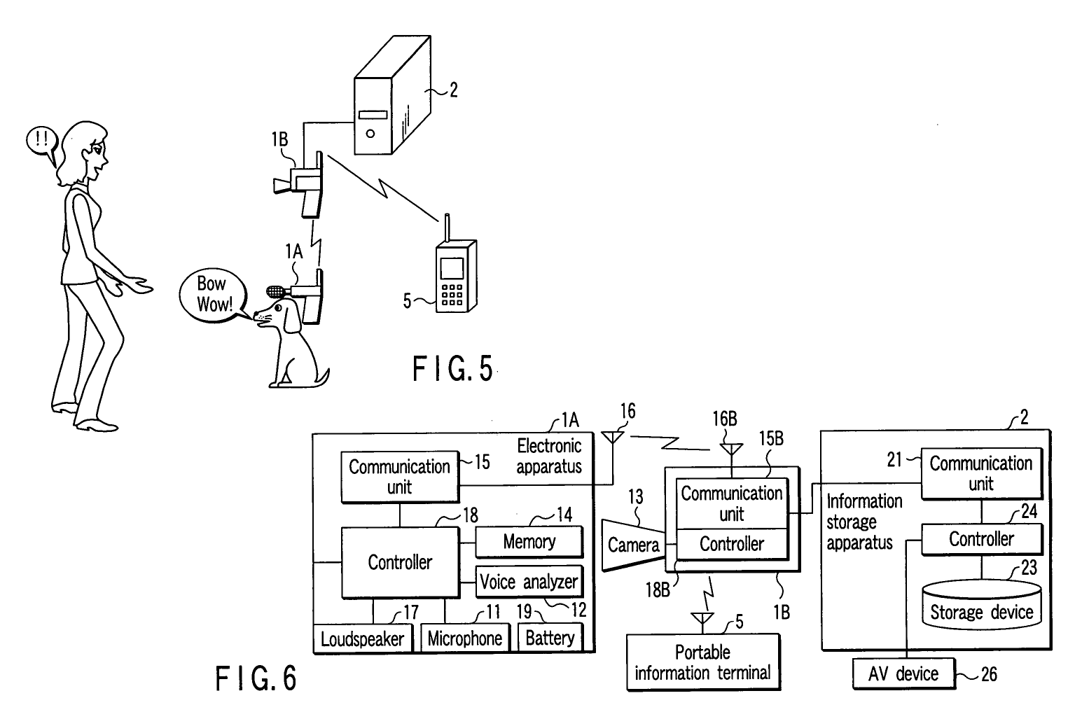

The arrangements of the electronic apparatus 1A and camera device 1B will be explained with reference to FIG. 6. The information storage apparatus 2 has the above-described arrangement. The portable information terminal 5 also has the above-described arrangement (see FIG. 3).

The electronic apparatus 1A is formed by excluding the camera 13 from the arrangement of the above-mentioned electronic apparatus 1 (see FIG. 2). When a voice analyzer 12 detects a voiceprint representing a threat, a controller 18 controls to wirelessly transmit audio information as information representing a peripheral situation from a communication unit 15 to the camera device 1B.

The camera device 1B includes a camera 13 separated from the electronic apparatus, a communication unit 15B, an antenna 16B, and a controller 18B. The camera 13 has the above-described arrangement. The communication unit 15B includes a radio communication device complying with wireless LAN, Bluetooth®, or the like, and a wire communication device complying with universal serial bus (USB), IEEE 1394, and the like. The communication unit 15B wirelessly communicates with the electronic apparatus 1A, and communicates with the information storage apparatus 2 by wire. The antenna 16B transmits and receives radio waves in wireless communication with the electronic apparatus 1A. When audio information is sent from the electronic apparatus 1A, the controller 18B controls to transmit information as a combination of image information photographed by the camera 13 and the audio information to the information storage apparatus 2 by wire, and to wirelessly transmit at least part of the information to the portable information terminal 5.

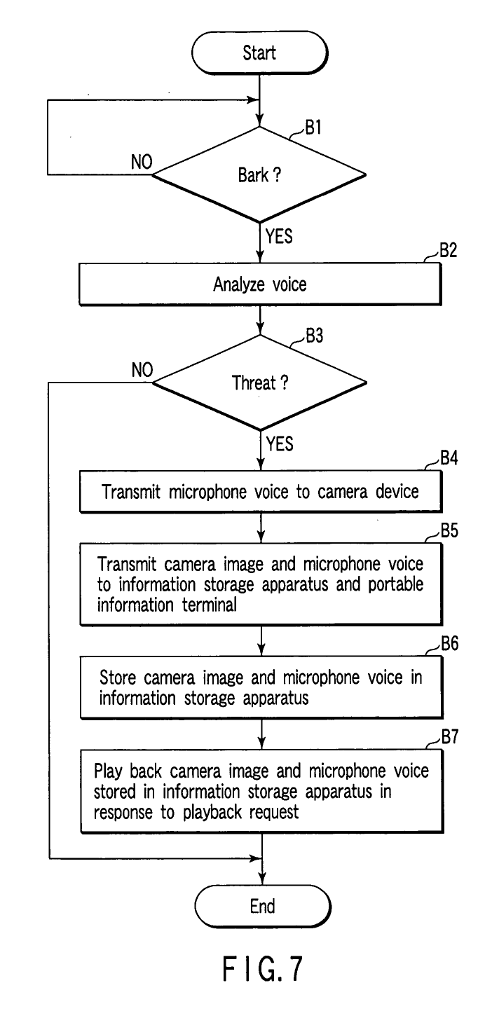

The operation in the second embodiment will be explained with reference to FIG. 7.

In the electronic apparatus 1A, the controller 18 waits until the bark of the watchdog is detected via a microphone 11 (NO in step B1). If the bark of the watchdog is detected (YES in step B1), the voice analyzer 12 analyzes the voiceprint (step B2). If no voiceprint representing a threat is detected (NO in step B3), the process ends. If a voiceprint representing a threat is detected (YES in step B3), the controller 18 transmits audio information collected by the microphone 11 to the camera device 1B via the communication unit 15 (step B4).

In the camera device 1B, when the audio information is received via the communication unit 15B, the controller 18B transmits information containing image information photographed by the camera 13 and the audio information to the information storage apparatus 2 via the communication unit 15B. Further, the controller 18B transmits at least part of the information to the portable information terminal 5 (step B5). The image information and audio information are respectively output from a display 54 and loudspeaker 55 of the portable information terminal 5. A person who carries the portable information terminal 5 with him can recognize the current situation around the watchdog.

In the information storage apparatus 2, a controller 24 stores in a storage device 23 the image information and audio information which have been received via a communication unit 21 (step B6). When a playback request is received, the controller 24 plays back the image information and audio information stored in the storage device 23 via an AV device 26 connected to the information storage apparatus 2 (step B7).

In this manner, the second embodiment can attain the same effects as those of the first embodiment. Since no camera need be attached to a watchdog, the burden on the watchdog can be reduced.

(Third Embodiment)

The third embodiment of the present invention will be explained. The same reference numerals as in the above-described embodiments denote the same parts, and a detailed description thereof will be omitted.

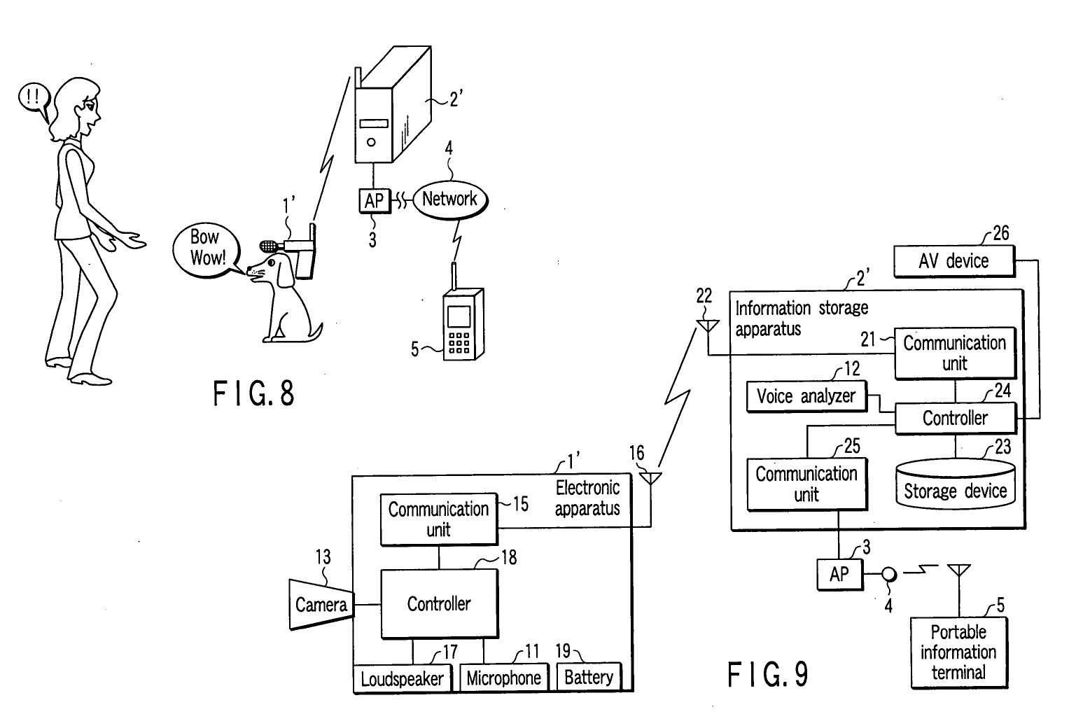

FIG. 8 is a view showing the configuration of a security system according to the third embodiment of the present invention.

In the third embodiment, when a watchdog expresses a feeling of threat against a suspicious person, the peripheral situation is transmitted to a portable information terminal carried by the resident via an information storage apparatus installed in the house.

As shown in FIG. 8, the security system includes an electronic apparatus 1′, information storage apparatus 2′, access point 3, network system 4, and portable information terminal 5.

The electronic apparatus 1′ is identical to the electronic apparatus 1 described in the first embodiment. The electronic apparatus 1′ in the third embodiment wirelessly transmits image information and audio information as information representing a peripheral situation to the information storage apparatus 21 when the bark of the watchdog is detected. In this case, the electronic apparatus 1′ does not execute any voiceprint analysis. The electronic apparatus 1′ does not directly transmit any information to the portable information terminal 5.

The information storage apparatus 2′ has the same arrangement as that described in the first embodiment, and further includes a voice analyzer which is mounted in the electronic apparatus 1 in the above embodiments. When a voiceprint representing a threat is detected, the information storage apparatus 2′ can transmit image information and audio information to the portable information terminal 5 via the access point 3.

The access point 3 performs a connection process between the information storage apparatus 2′ and the external network system 4. The access point 3 is incorporated in the information storage apparatus 2′.

The network system 4 includes a telephone line provided by a telephone company and a communication line provided by a service provider, and enables communication between the information storage apparatus 2′ and the portable information terminal 5.

The portable information terminal 5 is identical to that described in the first embodiment. The portable information terminal 5 according to the third embodiment receives information transmitted from the information storage apparatus 2′ via the network system 4.

The arrangements of the electronic apparatus 1′ and information storage apparatus 2′ will be explained with reference to FIG. 9. The portable information terminal 5 has the above-described arrangement (see FIG. 3).

The electronic apparatus 1′ is formed by excluding the memory 14 and voice analyzer 12 from the arrangement of the electronic apparatus 1 described in the first embodiment (see FIG. 2). When the bark of the watchdog is detected via a microphone 11, a controller 18 controls to wirelessly transmit image information and audio information as information representing a peripheral situation from a communication unit 15 to the information storage apparatus 2′.

The information storage apparatus 21 is formed by adding a voice analyzer 12 and communication unit 25 to the arrangement of the above-described electronic apparatus 1 (see FIG. 2). A storage device 23 substitutes for the function of the memory 14 in the arrangement of the electronic apparatus 1 (see FIG. 2). The voice analyzer 12 analyzes a voiceprint from the bark of the watchdog that is contained in audio information sent from the electronic apparatus 1′, and determines various feelings. When the voice analyzer 12 detects a voiceprint representing a threat, a controller 24 controls to transmit image information and audio information from the communication unit 25 to the portable information terminal 5 via the access point 3 and network system 4. The communication unit 25 performs network communication with the portable information terminal 5 via the access point 3 and network system 4.

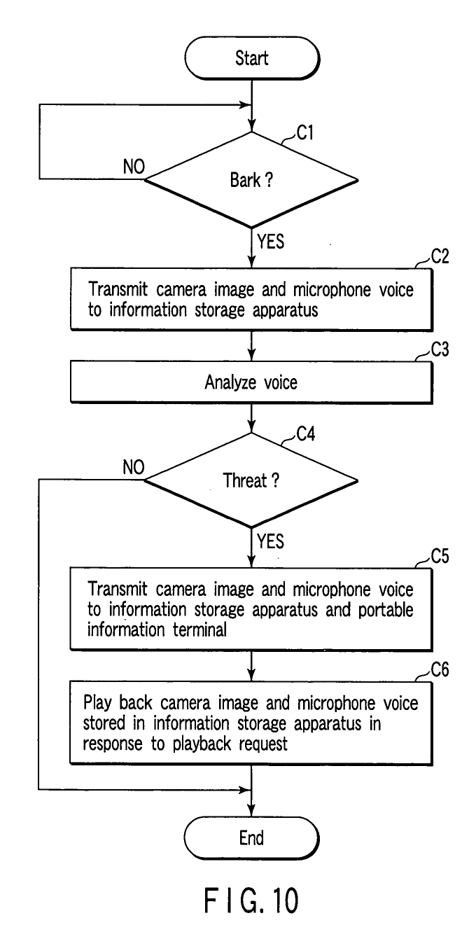

The operation in the third embodiment will be explained with reference to FIG. 10.

In the electronic apparatus 1′, the controller 18 waits until the bark of the watchdog is detected via the microphone 11 (NO in step C1). If the bark of the watchdog is detected (YES in step C1), the controller 18 transmits information containing image information photographed by a camera 13 and audio information collected by the microphone 11 to the information storage apparatus 2′ via the communication unit 15 (step C2).

In the information storage apparatus 2′, the controller 24 executes voiceprint analysis by using the voice analyzer 12 on the basis of the audio information sent from the electronic apparatus 1′ (step C3). If no voiceprint representing a threat is detected (NO in step C4), the process ends. If a voiceprint representing a threat is detected (YES in step C4), the controller 24 stores in the storage device 23 the information containing the image information and audio information, and transmits it to the portable information terminal 5 via the communication unit 25 (step C5). The image information and audio information are respectively output from a display 54 and loudspeaker 55 of the portable information terminal 5. A person who carries the portable information terminal 5 with him can recognize the current situation around the watchdog.

When a playback request is received in the information storage apparatus 21, the controller 24 plays back the image information and audio information stored in the storage device 23 via an AV device 26 connected to the information storage apparatus 2 (step C6).

According to the third embodiment, when the watchdog expresses a threat against a suspicious person, image information and audio information are transmitted as a peripheral situation from the information storage apparatus 2′ to the portable information terminal 5 via the access point 3 and network system 4. A person who carries the portable information terminal 5 with him can grasp the current situation around the watchdog even at a remote place away for the house.

(Fourth Embodiment)

The fourth embodiment of the present invention will be explained. The same reference numerals as in the above-described embodiments denote the same parts, and a detailed description thereof will be omitted.

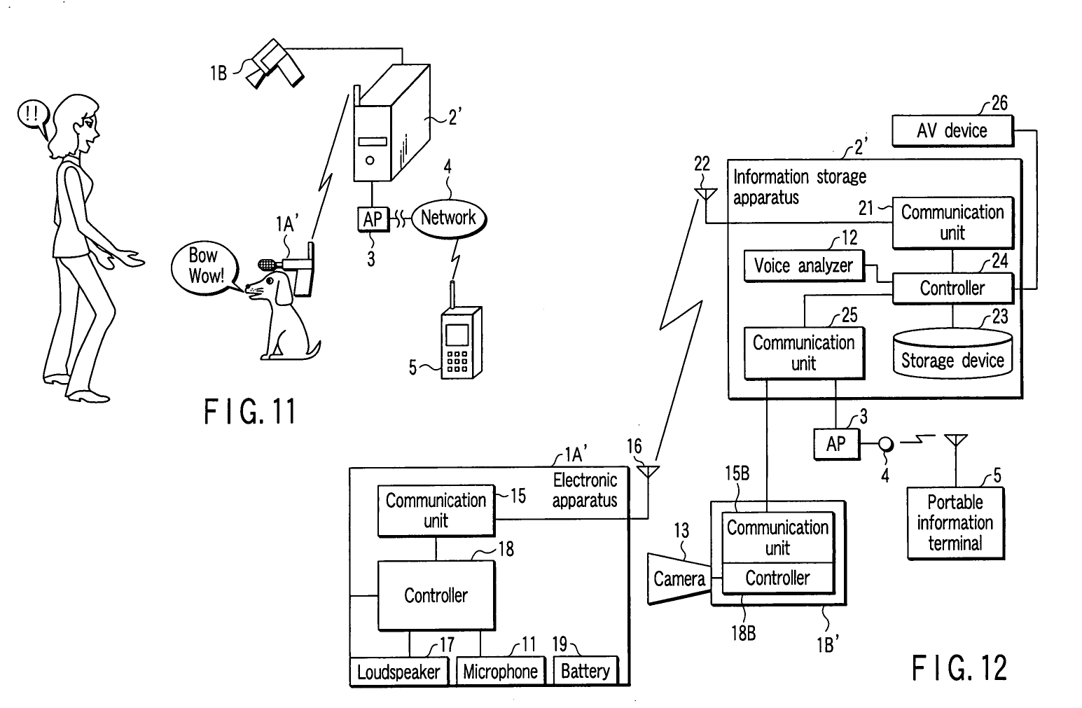

FIG. 11 is a view showing the configuration of a security system according to the fourth embodiment of the present invention.

In the fourth embodiment, a camera is separated from an electronic apparatus in the configuration of the third embodiment (see FIG. 8).

As shown in FIG. 11, the security system includes an electronic apparatus 1A′, camera device 1B, information storage apparatus 2′, access point 3, network system 4, and portable information terminal 5.

The electronic apparatus 1A′ is identical to the electronic apparatus 1′ described in the third embodiment except that the electronic apparatus 1A′ does not have any camera. When the bark of a watchdog is detected, the electronic apparatus 1A′ wirelessly transmits audio information as information representing a peripheral situation to the information storage apparatus 2′.

The camera device 1B is set at a place where a suspicious person can be easily photographed, for example, in the garden of a house or on the roof or a pillar. An image photographed by the camera device 1B is sent to the information storage apparatus 2′.

The information storage apparatus 2′ is identical to that described in the third embodiment. When a voiceprint representing a threat is detected from audio information sent from the electronic apparatus 1A′, the information storage apparatus 2′ according to the fourth embodiment transmits information containing image information photographed by the camera device 1B and the audio information to the portable information terminal 5 via the access point 3 and network system 4.

Note that the access point 3, network system 4, and portable information terminal 5 are identical to those described in the third embodiment.

The arrangements of the electronic apparatus 1A′, camera device 1B, and information storage apparatus 2′ will be explained with reference to FIG. 12. The access point 3 and network system 4 have the above-described arrangements. The portable information terminal 5 also has the above-described arrangement (see FIG. 3).

The electronic apparatus 1A′ is formed by excluding the camera 13 from the arrangement of the above-mentioned electronic apparatus 1′ (see FIG. 9). When the bark of the watchdog is detected via a microphone 11, a controller 18 controls to wirelessly transmit audio information as information representing a peripheral situation to the information storage apparatus 2′ via a communication unit 15.

The camera device 1B includes a camera 13 separated from the electronic apparatus, a communication unit 15B, and a controller 18B. The camera 13 has the above-described arrangement. The communication unit 15B is a communication device complying with USB, IEEE 1394, and the like, and communicates with the information storage apparatus 2′ by wire. The controller 18B transmits image information photographed by the camera 13 to the information storage apparatus 2′ via the communication unit 15B.

Unlike the third embodiment, a communication unit 25 in the information storage apparatus 2′ according to the fourth embodiment includes a radio communication device complying with wireless LAN, Bluetooth®, or the like, and a wire communication device complying with USB, IEEE 1394; and the like. The communication unit 25 performs network communication with the portable information terminal 5 via the access point 3 and network system 4, and wire communication with the camera device 1B. When a voice analyzer 12 detects a voiceprint representing a threat, a controller 24 controls to transmit information as a combination of image information sent from the camera device 1B′ and audio information sent from the electronic apparatus 1A′ from the communication unit 25 to the portable information terminal 5 via the access point 3 and network system 4.

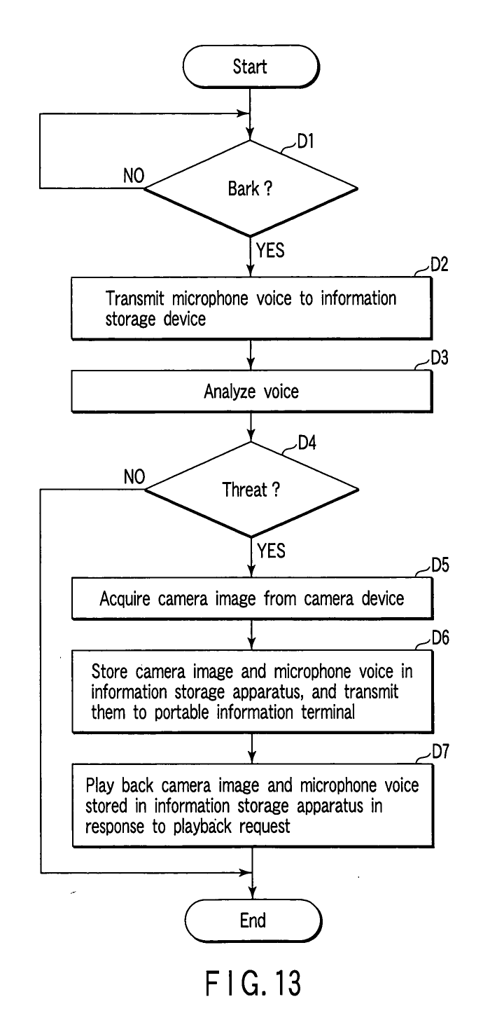

The operation in the fourth embodiment will be explained with reference to FIG. 13.

In the electronic apparatus 1A′, the controller 18 waits until the bark of the watchdog is detected via the microphone 11 (NO in step D1). If the bark of the watchdog is detected (YES in step D1), the controller 18 transmits information containing audio information collected by the microphone 11 to the information storage apparatus 2′ via the communication unit 15 (step D2).

In the information storage apparatus 2′, the controller 24 executes voiceprint analysis by using the voice analyzer 12 on the basis of the audio information sent from the electronic apparatus 1A′ (step D3). If no voiceprint representing a threat is detected (NO in step D4), the process ends. If a voiceprint representing a threat is detected (YES in step D4), the controller 24 acquires image information from the camera device 1B′ (step D5). The controller 24 stores information containing the image information and audio information in a storage device 23, and transmits it to the portable information terminal 5 via the communication unit 25 (step D6). The image information and audio information are respectively output from a display 54 and loudspeaker 55 of the portable information terminal 5. A person who carries the portable information terminal 5 with him can recognize the current situation around the watchdog.

When a playback request is received in the information storage apparatus 2′, the controller 24 plays back the image information and audio information stored in the storage device 23 via an AV device 26 connected to the information storage apparatus 2′ (step D7).

The fourth embodiment can obtain the same effects as those of the third embodiment. Since no camera need be attached to a watchdog, the burden on the watchdog can be reduced.

Note that wireless communication in the above-described embodiments may be replaced with wire communication, or wire communication may be replaced with wireless communication. Also when the voice analyzer detects a feeling of loneliness or frustration in addition to a feeling of threat, the portable information terminal may be notified of a message to this effect. A watchdog is utilized in the above embodiments, but the present invention is not limited to a dog and may utilize another animal. In the above embodiments, the peripheral situation is transmitted to a portable information terminal held by the resident. In addition, the peripheral situation may also be transmitted to a portable information terminal held by a supervisor in a security company or a specific person such as a neighbor.

As has been described in detail above, according to the present invention, it is possible to allow recognition out of the house of a peripheral situation such as that in which a suspicious person attempts to break into the house.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A security system comprising:
an analyzer configured to perform voiceprint analysis for bark of an animal; and
a communication unit configured to transmit information representing a peripheral situation around the animal to a terminal when the analyzer detects a voiceprint representing a threat.

2. The system according to claim 1, further comprising a camera configured to photograph the peripheral situation,
wherein the communication unit transmits an image photographed by the camera to the terminal.

3. The system according to claim 2, wherein the camera is mounted on the animal.

4. The system according to claim 3, wherein the communication unit is mounted on the animal.

5. The system according to claim 1, further comprising
an information storage apparatus configured to store the information representing the peripheral situation around the animal when the analyzer detects the voiceprint representing a threat, and
a playback unit configured to play back the information stored in the information storage apparatus.

6. The system according to claim 5, further comprising a camera configured to photograph the peripheral situation,
wherein the information storage apparatus stores an image photographed by the camera.

7. A security method comprising:
performing voiceprint analysis for bark of an animal; and
transmitting at least part of information representing a peripheral situation around the animal to a terminal when a voiceprint representing a threat is detected in the analysis.

8. The method according to claim 7, further comprising
photographing the peripheral situation by a camera, and
transmitting an image photographed by the camera to the terminal.

9. A security method comprising:
performing voiceprint analysis for bark of a specific animal;
storing information representing a peripheral situation around the animal in an information storage apparatus when a voiceprint representing a threat is detected in the analysis; and
playing back the information stored in the information storage apparatus in response to a playback response.

10. The method according to claim 9, further comprising
photographing the peripheral situation by a camera, and
storing an image photographed by the camera in the information storage apparatus.
